(19) United States
(12) Patent Application Publication
(10) Pub. No.: US 2006/0286269 A1
(43) Pub. Date: Dec. 21, 2006

(54) Process for granulation of edible seeds

(75) Inventors: Manoj Shah, Lindenhurst, IL (US); Andrew McPherson, Mt. Prospect, IL (US); Kristin G. Neale, Milwaukee, WI (US); Ramarathna Koka, Mt. Prospect, IL (US); Allan R. Olson, Kalamazoo, MI (US); Jan Karwowski, Midland Park, NJ (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 11/153,435

(22) Filed: Jun. 16, 2005

(51) Int. Cl. A23L 1/00

(52) U.S. Cl. 426/618

(57) ABSTRACT

A process for grinding edible seeds, such as grain and/or pulses, in a single unit operation in a continuous, short-duration controlled-temperature manner. Grinding may be effected without the need for moving mechanical parts. The granulated product obtained from the grinding treatment is stable to lipid oxidation. It also may be used in preparing instant whole grain food products.

### FIELD OF THE INVENTION

The invention generally relates to a process for grinding edible seeds, particularly grains and pulse seeds containing endogenous lipase.

### BACKGROUND OF THE INVENTION

Grain and other edible seed products are used in a wide variety of food products such as breads, cookies, breakfast cereals, crackers, meat extenders, beverages, and so forth. They also are used in animal feeds.

Grain crops are also known as cereal crops. Grains are the seed heads of grass plants. Major grain categories, include, for example, wheat, rice, corn, oats, barley, sorghum, triticale and rye, and so forth. Grains are consumed in large quantities in milled form, i.e., after being ground into flour or meal. Similarly, large amounts of pulse seeds, i.e., edible seeds of the plant family Leguminosae, and particularly soya beans, also are milled to provide flour forms thereof. Flours generally are finely ground products, while meals are crushed, lightly ground products. A conventional process of milling wheat, for example, has involved cleaning the grain, adding moisture to condition the grain so that the bran can be removed easily, and passing the grain through a grinding machine, such as a stone mill, roller mill, impact mill, hammer mill, ball mill, or another type of pressing system with mechanical parts, to grind the grain into flour. The bran may be separated from the flour depending on the type of flour product desired.

Some grains, such as oats, contain pro-oxidative enzymes such as lipoxygenase and lipase which can contribute to oxidation (rancidity) in the milled product during its shelf life. Heat treatments, and particularly, steam treatments, of oats (e.g., whole oat groats) have previously been used to stabilize (i.e., inactivate) such naturally-occurring enzymes in oats which otherwise may cause rancidity. The heat treatment of such grains necessitates an added process step and the costs associated therewith.

Also, farinaceous (starch-containing) foods, such as grains, can be subject to gelatinization or other significant physico-chemical transformations upon heat treatment or exposure to heat associated with conventional grinding or milling operations. For commercial reasons, control of lipid oxidation and gelatinization of farinaceous material in some food systems is important as it may have a direct impact on the grain product's desired functionality and final product quality. A grain product, such as flour, may not be economically and/or functionally useful if the original starch content becomes unduly degraded or lipid oxidation becomes too extensive.

Arrangements are needed for milling grains, particularly those containing endogenous lipoxygenase and/or lipase, in a shelf-stable, food grade, functional form which is resistant to lipid oxidation. The invention addresses the above and other needs in an efficient and economically feasible manner.

### SUMMARY OF THE INVENTION

This invention provides a process for milling edible seeds into granular products using vortex grinding; the products produced are more stable and less prone to lipid oxidation than conventional milled seed products. This process performs the treatment in a short-duration controlled-temperature operation that substantially preserves desirable functional aspects of the grain components which are useful for food manufacture. Endogenous oils and antioxidants in the edible seeds are homogenously incorporated with the pulverized particles resulting in a product which is stable and resistant to lipid oxidation. Air temperature within the processing unit is facilely controlled to provide improved shelf-stability and avoid destabilization of the edible seeds, such as in terms of providing and maintaining suitable sensory properties (e.g., taste, aroma) in the ground product for subsequent usage in food manufacture, reducing or avoiding starch damage such as in terms of controlling gelatinization to improve the ground product's functional performance such as in dough-making (e.g., in terms of texture, viscosity, etc.), inhibiting activity of pro-oxidative enzymes such as lipoxygenase and/or lipase activity, and/or controlling vaporization of natural antioxidants present in the grains. Grinding may be effected in a single stage operation without the need to contact the grain with any moving mechanical parts.

In one embodiment, the edible seeds comprise types of grains that may be milled such as, e.g., wheat, corn, oats, barley, nice, rye, sorghum, milo, rape seed, triticale and mixtures thereof. Also, grain side products like brans, such as wheat or rice bran, may be processed into a useful granular product. In another embodiment, the edible seeds comprise seeds of pulses, i.e., edible seeds of leguminous plants, which include, e.g., soya beans, kidney beans, peanuts, chickpeas, faba beans, field peas, lentils, lupins, mung beans, navy beans, and mixtures thereof.

In some embodiments, the edible seed milling is conducted as a grinding process in which compressed air (or other gas) and edible seeds are separately introduced into an apparatus including an enclosure that includes a truncated conical shaped section to effect vortex grinding. The compressed air may be introduced into the processing enclosure at ambient temperature, e.g., about 0° F. to about 100° F., particularly about 32° F. to about 90° F., and more particularly about 50° F. to about 85° F. Alternatively, the compressed air may be introduced in heated condition after treatment with air heating means, such as at temperatures less than about 275° F., particularly ranging from about 35° F. to about 275° F., particularly about 40° F. to about 270° F., and more particularly about 50° F. to about 265° F. Processing of the edible seeds at higher air temperatures may result in inferior granular products which have inferior baking quality and/or are oxidatively unstable, discolored, and/or heat scorched.

After introduction, the compressed air travels generally along a downward path through the enclosure until it reaches a lower end thereof. The air flows back up from the lower end of the enclosure in a central region thereof until exiting the enclosure via an exhaust duct. The edible seeds are separately introduced into an upper end of the enclosure, and the edible seeds become entrained in the air traveling downward through the enclosure until reaching the lower end of the enclosure. During this movement of the edible seeds from the upper end of the enclosure down to the lower end thereof, the edible seeds are at least physically processed. The seed material also may be further dehydrated by use of heated compressed air in which it is suspended in a dynamic air flow system.

During the same unit operation, the food is disintegrated into small particles in an extremely short period of time, which can be less than about 60 seconds, particularly less than about 30 seconds, and more particularly less than about 10 seconds. Significant amounts of the introduced edible seeds can be ground before reaching a lower end of the enclosure. As such, this attrition of the edible seeds into granular form may be achieved without a grinding device having moving mechanical parts in contact with the edible seeds for grinding.

Consequently, in these embodiments, a solid particulate product including ground food is discharged and recovered from the lower end of the enclosure, while air and any moisture vapor released from the food during processing within the unit is exhausted from the system via the exhaust duct. In one particular embodiment, the enclosure is a two-part structure including an upper cylindrical shaped enclosure in which the compressed air and edible seeds are separately introduced, and the cylindrical enclosure adjoins and fluidly communicates with a lower enclosure having the truncated conical shape that includes the lower end of the overall structure from which the processed feed material is dispensed.

Grinding edible seeds in accordance with embodiments of this invention offers numerous advantages over conventional schemes for milling edible seeds. The grinding treatment also may provide instantaneous grinding and homogenous dispersion of natural volatile antioxidants present in the edible seeds, e.g., vitamin E. Dispersion of natural antioxidant content of the edible seeds may help stabilize the end product against lipid oxidation (rancidity) by coating the ground end product with the antioxidant. Due to very short process time (e.g., generally less than about 10 seconds) conducted under a controlled non-excessive temperature (i.e., less than about 275° F.), antioxidant content will be less likely to be destroyed or excessively degraded.

In addition, ambient milled flour starch granules are not damaged, e.g., they are not significantly gelatinized, in the process of embodiments hereof to the degree that they are in traditional dry milled flours. Therefore, the resultant flour has comparable functionality to conventionally milled flours in certain applications such as cookies and crackers.

In edible seed milling applications for edible seeds containing endogenous lipoxygenase and/or lipase where temperature control may be particularly important, grinding methods according to embodiments of this invention inactivate the lipoxygensase and/or lipase to retard lipid oxidation in the product without the need to use conventional steam (heat) treatments used to inactivate endogenous lipoxygenase and/or lipase.

Increases in fat acidity and peroxide values tend to correlate with more rapid development of rancidity in edible seeds after they are ground. Fat acidity may be measured as free fatty acid content. Rancidity also may be detected via sensory tests, such as odor and/or flavors. Lipoxygenase is an enzyme that when active, breaks down fat into fatty acid esters (i.e., an oxidation process typical of rancidity). Hexanal is a major product of oxidative degradation of lipids, and measurements of levels of that compound in ground edible seeds provide a measure of the extent of oxidative degradation of lipid content that has occurred in the edible seed product. In embodiments of the present invention, edible seeds that are processed in accordance herewith without resort to mechanical milling contain comparatively smaller amounts or levels of fat acidity and/or hexanal as compared to identical edible seeds which instead have been milled mechanically, such as by hammer milling, to commercial flour particle sizes. In one embodiment, whole wheat grains milled in accordance with embodiments herein contain less than about 1000 ppm, particularly less than about 500 ppm linoleic acid, after 60 days storage at ambient conditions subsequent to grinding. In another embodiment, the lipoxygenase activity of whole wheat grains milled in accordance with embodiments herein is reduced at least 25%, particularly at least about 50%, and particularly at least about 60% as compared to a similar grain that instead is conventionally mechanical milling such as by roller(s) or hammer milling. In another embodiment, freshly ground grain (e.g., ground corn, rice, barley, rye, etc.) obtained in accordance with processing according to the present invention contains less than about 5 ppm hexanal, particularly less than about 3 ppm hexanal, more particularly less than about 1.5 ppm hexanal, and even more particularly less than about 0.5 ppm hexanal. In yet another embodiment, the particle size of the cyclonically processed corn flour obtained in accordance with processing according to the present invention is comparable to that of conventional mechanical dry-milled corn flour.

In another embodiment, an instant whole grain product is provided in which precooked grain is ground and dried using the herein-described cyclonic processing system, and the resulting instant product can be reconstituted with water into a food product. Shredded or flaked products are usually made from freshly cooked grains. However, in this embodiment precooked whole grains are ground and milled in one step within a very short time using cyclonic processing described herein. The instant grain product obtained can be conveniently packaged, stored, and subsequently or immediately further processed into the shapes or used as an instant ingredient in formulations including drinks. This embodiment provides a unique way of preprocessing grains that are fully cooked and shelf stable, and which are ready for further processing into the finished products by adding water, mixing, shaping, and baking or frying, etc. The finished whole grain products (e.g., snacks, cereals, etc.) have tender crispy/crunchy texture with the characteristics of the whole grain taste. The grains that can be processed in this manner in preparing such instant whole grain products are not particularly limited, and include, e.g., oats, rice, corn, wheat, or various combinations thereof.

Embodiments of this invention also make it possible to produce a granular food product from edible seeds in a relatively low temperature, short duration procedure. The grinding treatment preferably may be achieved as a single-stage operation without impairing the desirable functional attributes of the edible seeds, and without requiring different processes in different equipment. Additionally, the process can be operated in a continuous mode as the compressed air is continuously exhausted from the system after entraining the grain downward through the enclosure to its lower end, and ground edible seed material can be withdrawn from the lower end of the enclosure in an air-tight manner, such as by using a rotary air-lock. Relatively little if any food residue is left on the inner walls of the processing unit, making it easy to clean and facilitating switching to a different type of edible seeds for processing within the unit. These advantages improve product handling and increase production efficiencies by reducing process complexity, production time, production costs, and service maintenance and costs.

### BRIEF DESCRIPTION OF THE DRAWINGS

Other features and advantages of the invention will become apparent from the following detailed description of preferred embodiments of the invention with reference to the drawings, in which:

FIG. 1 is a flow chart of a method for processing edible seeds according to an embodiment of this invention.

FIG. 2 is a schematic view of a cyclonic grinding system useful for processing edible seeds according to an embodiment of this invention.

FIG. 3 is a cross sectional view of the cyclone grinding unit used in the processing system illustrated in FIG. 2.

FIG. 4 is a schematic view of a system useful for processing edible seeds according to another embodiment of this invention.

FIG. 5 is a graph showing a viscosity profile of a corn milled according to an embodiment of the present invention and a comparison viscosity profile of traditionally dry-milled corn flour, as measured on a Rapid Viscso Analyzer.

FIG. 6 is a bar graph showing the relative lipogenase activity of a white soft whole wheat flour prepared in accordance with an embodiment of the present invention as compared to several commercial sources of mechanically milled white soft whole wheat and red soft whole wheat flours.

FIG. 7 is a plot of the levels of linoleic acid as a function of storage days for white whole wheat and red soft whole wheat flours prepared in accordance with an embodiment of the present invention as well as several commercial sources of mechanically milled white soft whole wheat and red soft whole wheat flours.

FIG. 8 is a microphotograph (300×) of a sample of conventional milled red soft whole wheat.

FIG. 9 is a microphotograph (300×) of a sample of red soft whole wheat which was milled in a cyclone grinding unit according to an embodiment of this invention.

FIG. 10 is a bar graph showing the relative lipoxygenase activity of various soy flours prepared at different process temperatures in accordance with embodiments herein, and using unblanched or blanched soy bean feed materials, as well as a commercial source of mechanically milled soy flour.

FIG. 11 is a bar graph showing relative lipase activities of the soy flours referenced above in connection with FIG. 10

FIG. 12 is a bar graph showing relative lipase activities of various red kidney bean flours prepared at different process temperatures in accordance with embodiments herein, and using unblanched or blanched kidney bean feed materials, as well as a commercial source of mechanically milled kidney bean flour.

The features depicted in the figures are not necessarily drawn to scale. Similarly numbered elements in different figures represent similar components unless indicated otherwise.

### DETAILED DESCRIPTION OF THE PREFERRED EMBODIMENTS

Preferred embodiments of the invention will be described below with specific reference to unique processing of edible seeds. For purposes herein, the term “low-moisture” as used to characterize an edible seed material means seed material containing less than about 14 wt.% total water content, in liquid, frozen and/or vapor form.

Generally, edible seeds are ground into a small particle size within a short period of time in a grinding process performed in one unit operation. The grinding process is implemented on a cyclonic type system that may be operated in a manner whereby the edible seeds may be physically acted upon in a beneficial manner. A ground food product is obtained in a granulated form (e.g., a solid fine particulate). For purposes herein, “grinding” a particle means crushing, pulverizing, abrading, wearing, or rubbing the particle to break it down into smaller particles and/or liberate smaller particles, and includes mechanisms involving contact between moving particles, and/or between a moving particle and a static surface; and “drying” means dehydrating or reducing moisture content. “Stable” or “shelf-stable” refers to resistance to going rancid. For example, a more stable food product can be stored under similar conditions for a longer period of time than a less stable food product before going rancid. The presence of rancidity can be monitored and measured in a multiplicity of different manners, including sensory testing (e.g., taste and/or or odor analysis), lipoxygenase activity level measurements, free fatty acid level measurements, and/or hexanal level measurements,

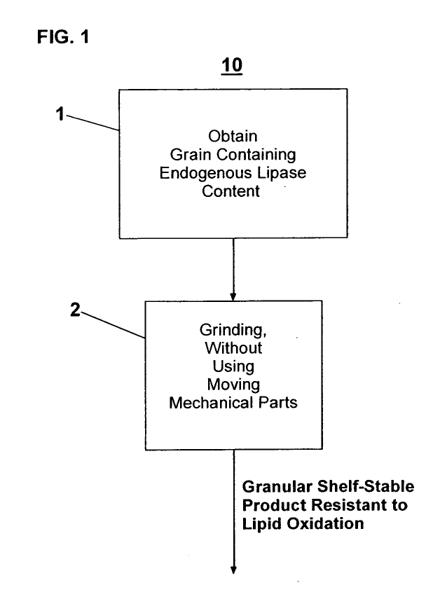

Referring to FIG. 1, in this illustrated embodiment edible seeds containing endogenous lipoxygenase and/or lipase is collected (step 1), then is subjected to a single-stage grinding treatment (step 2), providing a granular product which is more stable and less prone to lipid oxidation.

In step 2, a granular food product is obtained which is suitable for use in comestibles. For instance, the granulated food product obtained substantially retains its flavor and functional attributes through the grinding treatment. The granular food product also may be stably stored until used in subsequent food production.

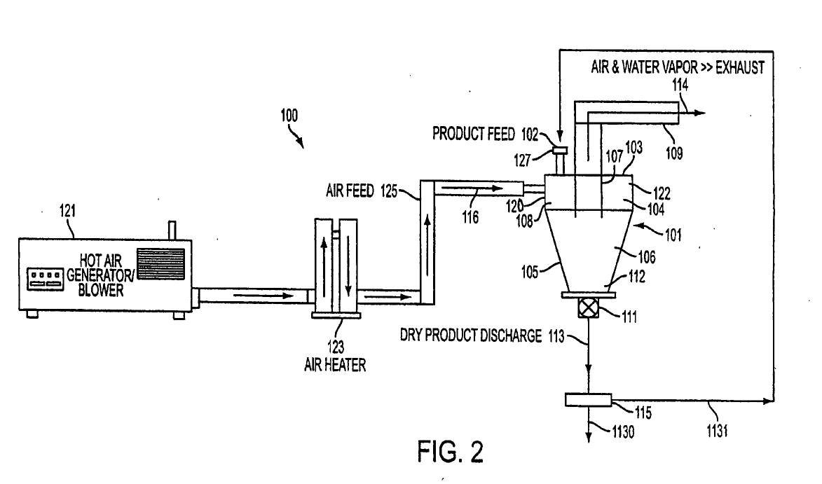

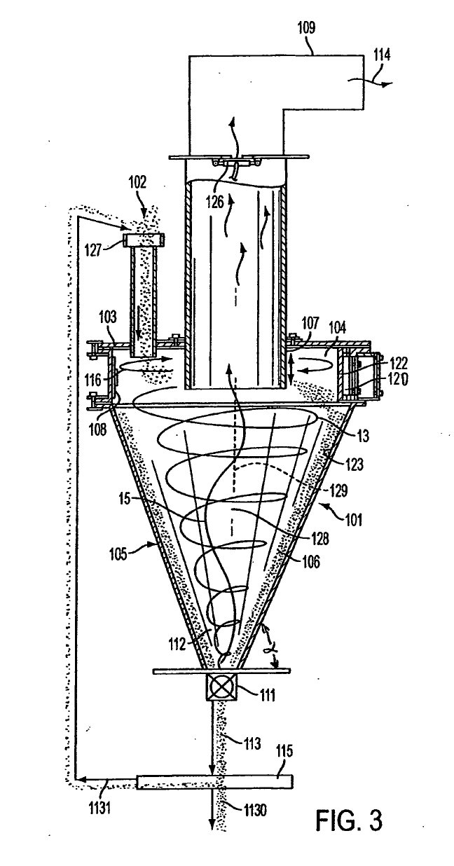

Referring now to FIGS. 2 and 3, details of an exemplary equipment arrangement and process of operating it for conducting the grinding of the edible seeds in step 2 of FIG. 1 are discussed hereinafter. The edible seeds that are introduced into the cyclonic system for treatment in the process of this invention may be derived from commercial food manufacture or other sources of edible seed materials. The edible seeds may be in the form of discrete whole pieces as originally manufactured, or as portions, parts, fragments, shreds, fragments, and so forth thereof.

Referring to FIG. 2, an exemplary system 100 for performing grinding of edible seeds according to a process embodiment of this invention is shown. Cyclone 101 is a structural enclosure comprised of two fluidly communicating sections: an upper cylindrical enclosure 103 defining a chamber 104; and a lower truncated conical shaped enclosure 105 that defines a cavity 106. Both the upper and lower enclosures are annular structures in which a solid wall or shell encloses an interior space. In this illustration, the upper enclosure 103 has a generally uniform cross-sectional diameter, while the lower enclosure 105 tapers inward towards its lower end 112. In a non-limiting embodiment, the taper angle a of lower enclosure 105 may range from about 66 to about 70 degrees (see FIG. 3). For purposes herein, the terminology “enclosure” means a structure that encloses a chamber, cavity, or space from more than one side.

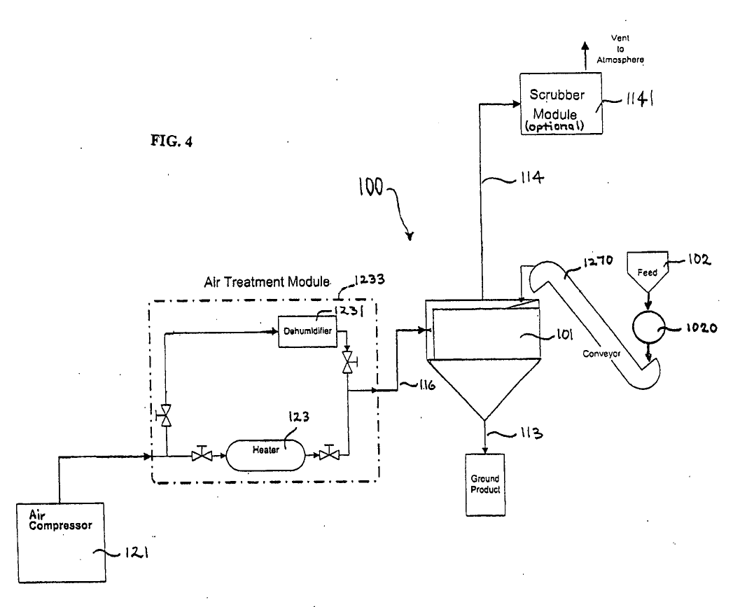

Compressed air 116 and edible seeds 102 are separately introduced into the cyclone 101 at the upper enclosure 103. The processed edible seeds are discharged as a solid particulate 113 from the lower end 112 of the cyclone 101. A valve mechanism 111, such as a rotary valve or rotary air-lock, is shown that permits extraction of dried, ground food product from the cyclone without interrupting continuous operation of the system and which minimizes leakage of the introduced air from the cyclone 101. If the cyclone 101 is operated without an air-lock or the like at the bottom discharge end of the cyclone 101, the system generally will run less efficiently as air will be forced out of the lower end 112, which will need to be compensated for in the air feed rate. Air, and possibly some small amount of moisture vapor released from the low-moisture food during treatment within the cyclone 101, is exhausted as exhaust gases 114 from the cyclone via sleeve 107 and exhaust duct 109. Some nominal amount of chaff or other light debris may be liberated from the food during processing in the cyclone, and may be eliminated with the exhaust gas stream 114. The exhaust gas stream 114 optionally may be particle filtered, and/or scrubbed to strip out volatile compounds or other compounds, such as using a separate scrubber module, e.g. a packed bed type scrubber, before it is vented to the atmosphere (e.g., see FIG. 4, feature 1141). Sieving device 115 is described in more detail later herein. Generally, it is used to separate the oversize or coarser product 1131, i.e., the unground portion in particulate product 113, from the finer ground portion 1130 of the edible seeds discharged from the cyclone 101.

To introduce the compressed air 116 into cyclone 101, an air pressurizing mechanism 121, such as a blower or air compressor, generates a high volume, high velocity compressed air stream that is conducted via air ducting 125 through an optionally used air heater 123, and from there is introduced into upper enclosure 103 of cyclone 101. Heating the compressed air before its introduction into the cyclone 101 is not necessarily required. However, it may be used for added moisture content control or adjustment in the product, if desired. For purposes herein, the term “compressed air” refers to air compressed to a pressure above atmospheric pressure, e.g., above 14.7 psia (lb./inch² absolute). The term “heated air” refers to air heated to a temperature above ambient temperature, e.g., above 75° F. (24° C.). The term “compressed heat air” refers to air having both these characteristics.

The compressed air 116 is introduced into chamber 104 substantially tangentially to an inner wall 108 of the upper enclosure 103. This can be done, for example, by directing the air stream 116 to a plurality (e.g., 2 to 8 holes) of holes 120 circumferentially spaced around and provided through the wall 108 of the upper enclosure 103 through which the air stream is introduced. Deflection plates 122 can be mounted on inner wall 108 of upper enclosure 103 for deflecting the incoming stream of air into a direction substantially tangential to the inner wall 108 according to an arrangement that has been described, for example, in U.S. patent application publication no. 2002/0027173 Al, which descriptions are incorporated herein by reference. The compressed air may be introduced into the upper enclosure 103 of cyclone 101 in a counter-clockwise or a clockwise direction.

The introduced air 10 generally may be further pressurized cyclonically in the chamber 104 and cavity 106. Due to the centrifugal forces present in the cyclonic environment, it is thought that the pressure nearer the outer extremities of the cavity 106 is substantially greater than atmospheric pressure, while the pressure nearer the central axis of the cavity 106 is less than atmospheric pressure. As shown in FIG. 3, as a non-limiting illustration, after being introduced into upper enclosure 103, the compressed air 116 spirals or otherwise travels generally along a large downward path as a vortex 13 through the upper enclosure 103 and the lower conical shaped enclosure 105 until it reaches a lower end 112 thereof. In this illustration, near the lower end 112 of the cavity 106 defined by the inner walls 123 of lower enclosure 105, the downward direction of the air movement is reversed, and the air (and any moisture vapor released from the food during treatment within the cyclone 101) whirls back upwardly as a smaller vortex 15 generally inside the larger vortex 13. The smaller vortex 15 flows back up from the lower end 112 of the lower enclosure 105 in a central region 128 located proximately near the central axis 129 of the cyclone 101 and generally inside the larger vortex 13. The smaller vortex 15 flows upward until exiting the enclosure via sleeve 107 and then exhaust duct 109.

A vortex breaking means (not shown) optionally can be interposed below or inside the lower end 112 to encourage the transition of the larger vortex 13 to the smaller vortex 15. Various vortex breaking arrangements for cyclones are known, such as the introduction of a box-shaped enclosure at the bottom of the conical enclosure.

The edible seeds 102 are separately introduced into upper enclosure 103. The introduced edible seeds drop gravitationally downward into chamber 104 until entrained in the air vortex 13 within cyclone 101. Preferably, the edible seeds are introduced into upper enclosure 103 in an orientation such that it will fall into the cyclonic vortex 13 generated within cyclone 101, located in the space between the sleeve 107, and inner wall 108 of the upper enclosure 103. This feed technique serves to minimize the amount of edible seeds that may initially fall into extreme inner or outer radial portions of the vortex where the cyclonic forces that the food experiences may be lower.

The entrained food travels in the vortex 13 of air spiraling or otherwise traveling downward through the lower enclosure 105 until reaching the lower end 112 of the lower enclosure 105. During this downward flow path, the edible seeds are ground. The grinding effects on the edible seeds may occur at different respective times, and/or several of the effects may occur simultaneously at a particular point or points in time, during the downward flow path of the edible seeds through the cyclone. While not desiring to be bound to theory, it is thought that possible pressure-gradient and coriolis forces across, cavitation explosions, and the collision interaction between the food particles entrained in the high-velocity cyclonically pressurized air may be violently disruptive to the physical structure of that material. Alternatively, or in addition thereto, the centrifugal force of the vortex may move the edible seeds forcefully against inner walls 108 and 123 of the enclosure. These modes of attrition, individually or in combination, or other modes of attrition that may occur within the cyclone which may not be fully understood, bring about comminuting (grinding) of the edible seeds. As a result, during this movement of the food from the upper enclosure 103 down to the lower end 112 of the lower enclosure 105, the edible seeds are physically processed in beneficial ways. The unit 101 does not have and requires no mechanical moving parts for effecting grinding/milling of the edible seeds.

In a further embodiment of the invention, the discharged solid particulate product 113 can be screened, such as using a sieve, or other suitable particulate separation/classifying mechanism 115, to sort and separate the finer fraction of ground food 1130 in the solid particulate product 113 that have particle sizes meeting a size criterion, such as being less than a predetermined size, which are suitable for post-grinding processing, from the coarser product fraction 1131. The coarser (oversize) product fraction 1131 can be redirected into the upper enclosure of the cyclone for additional processing therein. A conveyor (not shown) could be used to mechanically transport the coarser material back to feed introducing means 127 or other introduction means in upper enclosure 103 of cyclone 101. Also, feed introducing means 127 may be an inclined conveyor (e.g., see FIG. 4, feature 1270), which transports feed material from a lower location up to and into chamber 104 of the cyclone 101 at the upper enclosure 103.

It will be appreciated that sleeve 107 can be controllably moved up and down to different vertical positions within cyclone 101. In general, the lower sleeve 107 is spaced relative to the cavity 106, the smaller the combined total volume of the cyclone 101 which is available for air circulation. Since the volume of air being introduced remains constant, this reduction in volume causes a faster flow of air, causing greater cyclonic effect throughout cavity 106 and consequently causing the introduced food to be ground to circulate longer in the chamber 104 and the cavity 106. Raising the sleeve 107 generally has the opposite effect. For a given feed and operating conditions, the vertical position of sleeve 107 can be adjusted to improve process efficiency and yield.

Also, a damper 126 can be provided on exhaust duct 109 to control the volume of air permitted to escape from the central, low-pressure region of cavity 106 into the ambient atmosphere and can affect the cyclonic velocities and force gradients within cyclone 101. The damper may affect conditions within the unit 101 but is not considered to be associated with grinding the seeds within the unit.

By continually feeding edible seeds into cyclone 101, a continuous throughput of ground food product material 113 is obtained. A non-limiting example of a commercial apparatus that can be operated in a continuous manner while processing food according to processes of this invention is a WINDHEXE apparatus, manufactured by Vortex Dehydration Systems, LLC, Hanover Md. Descriptions of that type of apparatus are set forth in U.S. patent application publication no. 2002/0027173 A1, which is incorporated in its entirety herein by reference.

The cyclonic system 100 can provide very high heat transfer rates from hot air to edible seeds for any further drying or moisture control that may be optionally desired, and mechanical energy to crack and granulate edible seeds or a edible seed component as it descends through the conical section of the dryer. The food exiting the cyclone 101 exhibits a flowable solid particulate type form, which may be a flour or powder like material.

The processing unit 101 may be left relatively clean and tidy, as low-moisture processed material does not tend to cling as residue to the interior walls of the process unit used to grind the edible seeds into granular form. This can facilitate any desired change-over for processing a different type of feed material within the same unit.

In one process scheme for processing edible seeds, the introduction of the compressed air into the cyclone comprises supplying compressed at a pressure within the range of from about 10 psig (lb./inch² gauge) to about 100 psig, particularly from about 30 psig to about 60 psig, and more particularly from about 35 psig to about 50 psig.

As noted, heating of the compressed air before its introduction into the processing unit is not ordinarily required for processing the edible seeds according to embodiments herein. Moreover, it has been found that processing of the edible seeds at certain elevated air temperatures results in inferior destabilized products. If heated compressed air is used, heated air may be introduced into the cyclone at an appropriate temperature for the edible seeds being processed which does not cause destabilization thereof. The compressed air may be introduced into the processing enclosure at ambient temperature, e.g., about 0° F. to about 100° F., particularly about 32° F. to about 90° F., and more particularly about 50° F. to about 85°. Alternatively, the compressed air may be introduced in heated condition after treatment with air heating means, such as at temperatures less than about 275° F., particularly ranging from about 35° F. to about 275° F., particularly about 40° F. to about 270° F., and more particularly about 50° F. to about 260° F. As the feed material becomes lower in moisture content, the need for heated air, within the above criterion, may be reduced or eliminated in most instances.

The volumetric introduction rate of the compressed air into the cyclone is within the range of from about 500 cubic feet per minute (CFM) to about 10,000 cubic feet per minute, particularly from about 800 cubic feet per minute to about 10,000 cubic feet per minute, and more particularly from about 1,000 cubic feet per minute to about 3,000 cubic feet per minute.

The feed rate of the edible seeds can vary, but generally may be in the range of about 1 to about 300 pounds per minute, particularly about 50 to about 150 lbs./min, for about a 1 to about a 10 foot diameter (maximum) cyclone. The cyclone diameter may be, for example, about 1 to about 10 feet in diameter, particularly about 1 to about 6 feet in diameter.

The edible seeds may be processed within the above-noted cyclone arrangement within a very short period of time. In one embodiment, upon introducing the edible seeds into the cyclone, a granulated product thereof is discharged from the processing unit within about 15 seconds, and particularly within about 1 to about 5 seconds. Substantially all the introduced edible seeds may be discharged as processed product within such a short period of time.

Endogenous oils and antioxidants in the edible seeds are homogenously incorporated with the pulverized particles. The dispersion of these naturally-occurring antioxidant constituents throughout the granular product may result in a product which is more stable to lipid oxidation. Air temperature within the processing unit may be facilely controlled to control vaporization of natural antioxidants present in the edible seeds. Also, air temperature within the processing unit may be facilely controlled to control vaporization of natural antioxidants present in the edible seeds.

The above-noted processing temperatures and durations applied during grinding of the edible seeds generally are also low enough to help prevent any significant undesired changes in the starch structure, or other physico-chemical attributes relevant to flour manufacture, from occurring during the grinding treatment such as described herein. Any starch content present in the edible seeds (before granulation) is preserved substantially intact through the grinding treatment performed in accordance with this invention on the edible seeds. Conventional milling generally employs moving parts to effect attrition of a material, which tends to generate localized high heat. Intense or unduly elevated temperature may increase the risk of degradation of desirable food functional features.

In one embodiment, the edible seeds used as the feed material in the present invention generally contains less than 14 wt. % moisture, and particularly less than 12 wt. % moisture, and generally ranges from 1 wt % to 14 wt % moisture, and particularly from 6 wt % to 12 wt %, when introduced into the cyclone 101 of system 100. Feed material at higher moisture levels may also be used to the extent it does not agglomerate or build-up inside the cyclone or otherwise become non-processable. The compressed air fed into the cyclone ordinarily is unheated. In one embodiment, the food material is processed at ambient (nonheated) temperature, such as at a temperature of about 65 to about 80° F. (about 18 to about 27° C.). It may be necessary to dehumidify the compressed air before it is introduced into the cyclone unit in high relative humidity (RH) conditions (e.g. RH greater than about 50%) to ensure that the feed material can be attrited into granular form and does not build-up into a sticky or pasty mass inside the cyclone. The air may be dehumidified using a conventional cooling coil unit or similar device used for dehumidification of process air (e.g., see FIG. 4, feature 1231). The dehumidifier or air dryer 1231 may be a commercial unit for the general purpose, e.g., a Model MDX 1000 air dryer from Motivair, Amherst, N.J.

Under certain conditions, the compressed air fed into the cyclone may be heated in an air heater 123 before its introduction into the cyclone unit 101 (see FIG. 4). The heater 123, and dehumidifier 1231, are units of the subsystem represented as the air treatment module 1233 in FIG. 4. As indicated in FIG. 4, control valves and the like may be used to selectively control and manage air flow through the various air treatment units in module 1233. The ground (granulated) food product obtained from the process also generally may contain less than 14 wt % moisture, or otherwise the same or lower level of moisture as the feed material to the extent no additional moisture is introduced during processing in the cyclone.

The granulated product obtained by grinding processing in accordance with embodiments herein have commercially useful particle sizes. In one embodiment, the dried, ground food product obtained by processing edible seeds according to an embodiment of this invention generally may have an average particle size of about 1 micron to about 1,000 microns, particularly about 2 to about 1,000 microns. In one embodiment, the solid particulate product obtained as the bottoms of the cyclone comprise at least about 50% ground food product having an average particle size of about 1 micron to about 1,000 microns.

The granular product obtained in accordance with embodiments of this invention is edible and may be used in a wide variety of foodstuffs for a variety of purposes. The granulated product does not have an unpleasant taste or odor due to processing, and may be easily processed with doughs, processed meats, and so forth without loss of quality. The granulated product obtained generally is shelf stable, and may be used to impart functional and/or flavor properties to a food product being manufactured after many months of storage of the granulated product; generally storage times of about twelve months storage/shelf life or more are possible.

In some preferred embodiments, the edible seeds processed according to an embodiment of this invention comprise whole grains, dehulled grains, or one or more principal parts of cereal grain, such as the pericarp or bran (external layer of grain), the endosperm (farinaceous albumen containing starch), and/or the germ (seed embryo), as well as components thereof. Examples are grains which may be processed according to embodiments herein include, for example, grains derived from cultivated grasses. Specific examples of the grains include, for example, wheat, maize (e.g., corn), oats, barley, rice, rye, sorghum, milo, millet, rape seed, triticale and mixtures or combinations thereof, as well as various milling (side) products of such cereal grains, such as bran. The edible seeds also may comprise seeds of pulses. These edible seeds can be derived from the plant family Leguminosae, which include, e.g., soya beans, kidney beans, peanuts, chickpeas, faba beans, field peas, lentils, lupins, mung beans, and navy beans; mixtures of such seeds may also be used.

The products obtained from processing the edible seeds according to embodiments herein are in granular form, such as flours, meals, granulated starches or glutens, and mixtures thereof. They may be used in the preparation of diverse food products, such as breads, cookies, breakfast cereals, crackers, meat extenders, beverages, and so forth. Also, grain side products like brans, such as wheat or rice bran, may be processed into a granular product. The ground bran may be used, for example, as a food extender, filler, and/or in animal feeds. The ground grain product also may be used in non-food applications, such as in the cosmetic industry as talc replacers and in skin care products.

In another embodiment, an instant whole grain product is provided in which precooked grain is ground and dried in a WINDHEXE apparatus, and the resulting instant product can be reconstituted with water into a food product. Shredded or flaked products are usually made from freshly cooked grains. However, in this embodiment precooked whole grains are ground and milled in one step within a very short time using cyclonic processing described herein. The instant grain product obtained can be conveniently packaged, stored, and subsequently or immediately further processed into the shapes or used as an instant ingredient in formulations including drinks. This embodiment provides a unique way of preprocessing grains that are fully cooked and shelf stable, and which are ready for further processing into the finished products by adding water, mixing, shaping, and baking or frying, etc. The finished whole grain products (e.g., snacks, cereals, etc.) have tender crispy/crunchy texture with the characteristics of the whole grain taste. The grains that can be processed in this manner in preparing such instant whole grain products are not particularly limited, and include, e.g., oats, rice, corn, wheat, or various combinations thereof.

The grinding unit such described herein permits relatively short duration, low temperature processing to be used to yield a granular product, which is thought to help inactivate pro-oxidative lipoxygenase, lipase and other similar enzymes content to retard lipid oxidation and make the product more shelf stable. The grinding treatment provides instantaneous grinding and homogenous dispersion of natural volatile antioxidants present in the edible seeds, e.g., vitamin E (i.e., one or more of alpha-tocopherol, delta-tocoperol, gamma-tocopherol, and/or naturally occurring salts thereof such as acetates thereof). This is thought to stabilize the end product against lipid oxidation (rancidity) by coating the ground end product with the antioxidant without destroying or excessively degrading the antioxidant due to very short process time conducted under a controlled non-excessive temperature.

In milling applications for edible seeds containing endogenous lipoxygensase and/or lipase, such as oats, where temperature control may be particularly important, grinding methods according to embodiments of this invention inactivate the lipoxygensase and/or lipase to retard lipid oxidation in the product without the need to use conventional steam (heat) treatments used to inactivate endogenous lipoxygensase and/or lipase. Starch granules also are not damaged to the degree that they are in traditional dry milled flours. Moreover, as has been observed and confirmed via microscopy, the starch granules in the resulting flour processed in accordance with embodiments herein are spherical in shape rather than the typical flattening that occurs in roller milling.

Edible seeds ground according to embodiments herein are more shelf-stable and less apt to go rancid, as compared to similar edible seeds that have been ground according to conventional mechanical milling techniques. For instance, in one embodiment, whole wheat grains milled in accordance with embodiments herein contain less than about 1000 ppm, particularly less than about 500 ppm of the free fatty acid linoleic acid, after 60 days storage at ambient conditions subsequent to grinding. In another embodiment, the lipoxygenase activity of whole wheat grains milled in accordance with embodiments herein is reduced at least 25%, particularly at least about 50%, and particularly at least about 60% as compared to a similar grain that instead is conventionally mechanical milling such as by roller(s) or hammer milling. In another embodiment, freshly ground grain (e.g., ground corn, rice, barley, rye, etc.) obtained in accordance with processing according to the present invention contains less 5 ppm hexanal, particularly less than 3 ppm hexanal, more particularly less than 1.5 ppm hexanal, and even more particularly less than 0.5 ppm hexanal. In yet another embodiment, the viscosity of the cyclonically processed corn flour obtained in accordance with processing according to the present invention is comparable to that of conventional mechanical dry-milled corn flour.

For instance, flours made by edible seeds processed in accordance with embodiments herein have improved shelf-stability and functionality over conventionally milled flours in certain applications, such as dough-based product manufacture (e.g., cookies, crackers, snack foods).

The granular products may be used in the manufacture or preparation of a wide variety of foods, including, for example, dough-based materials. Such dough-based materials may be, for example, bread doughs, pizza doughs, pastry doughs, cereals, pet foods, crackers, baked goods, snack foods, pastas, and so forth. The granulated product obtained may be used at appropriate baking levels for the food application of interest. Food products function positively when formulated with flours milled without moving mechanical parts as described in accordance with embodiments of the present invention.

The Examples that follow are intended to illustrate, and not limit, the invention. All percentages are by weight, unless indicated otherwise.

### EXAMPLES

### Example 1

Dry whole corn (Commodity USDA #2 yellow dent whole corn, Cargill) was fed into a WINDHEXE apparatus for circular vortex air-flow material grinding. The WINDHEXE apparatus was manufactured by Vortex Dehydration Systems, LLC, Hanover, Md., U.S.A. The basic configuration of that type of apparatus is described in U.S. patent application publication no. 2002/0027173 A1, and reference is made thereto. The process unit had four inlet ports equidistantly spaced around the upper portion of the apparatus through which the compressed air stream was concurrently introduced in a counter-clockwise direction.

A two-foot diameter WINDHEXE apparatus was used. The diameter size refers to the chamber size of the enclosure into which air and grain introductions were made. The conditions of this experiment are described below. The feed rate of the low-moisture crackers was set for an approximate discharge of 3 pounds solid product per minute, and approximately 20 pounds of food material was tested in the apparatus. The grain was loaded into a hopper that directly fed onto a three-inch belt conveyor that fed into the WINDHEXE apparatus. The WINDHEXE apparatus was operated with compressed air introduced at 200-350° F., an air introduction rate of 1000 cubic feet per minute (cfm) and a pressure of 40-50 psig.

A granulated product exiting the apparatus was in finely ground, flour-like, form. This granulated food product was discharged from the bottom of the cyclone in about two seconds after the grain had been introduced into the processing unit. The granulated food product obtained had an average particle size of about 1 to about 500 microns, and a moisture content of about 6-8%.

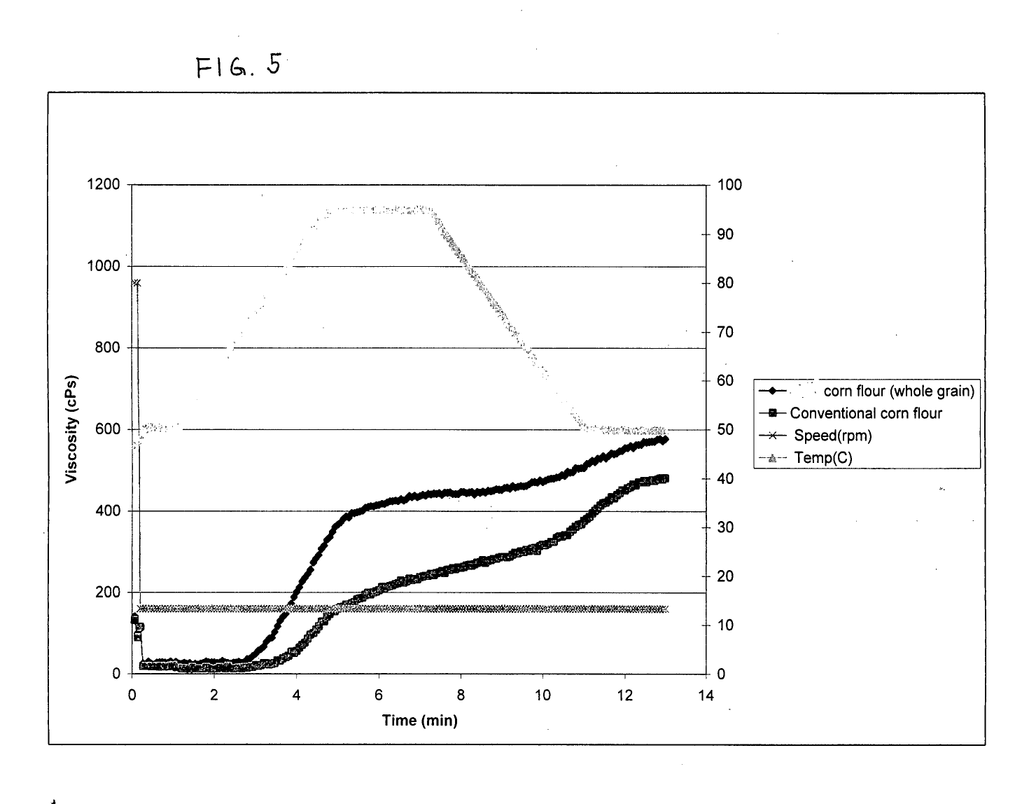

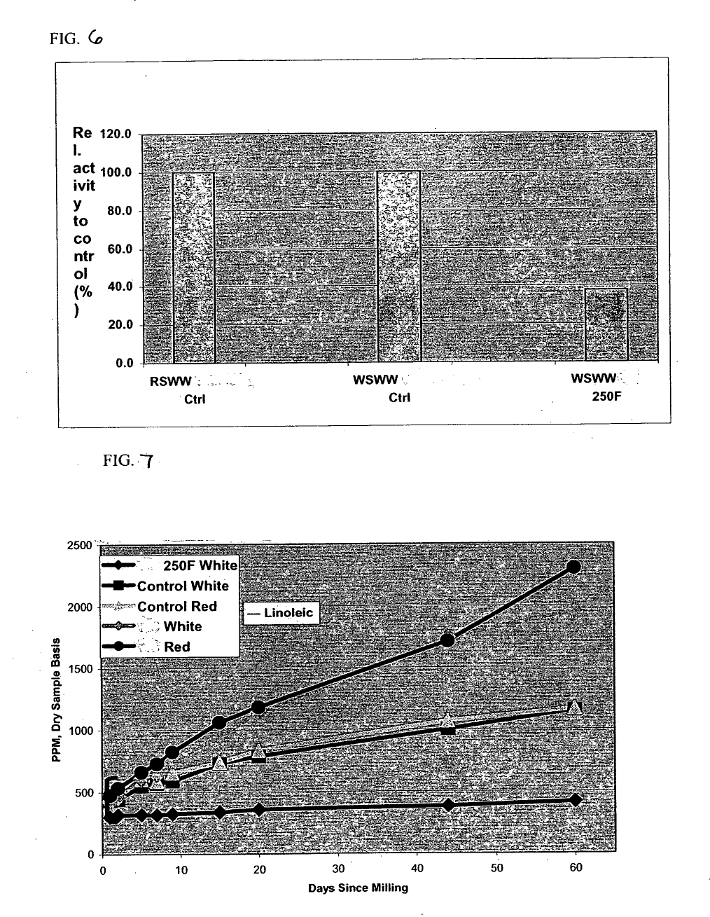

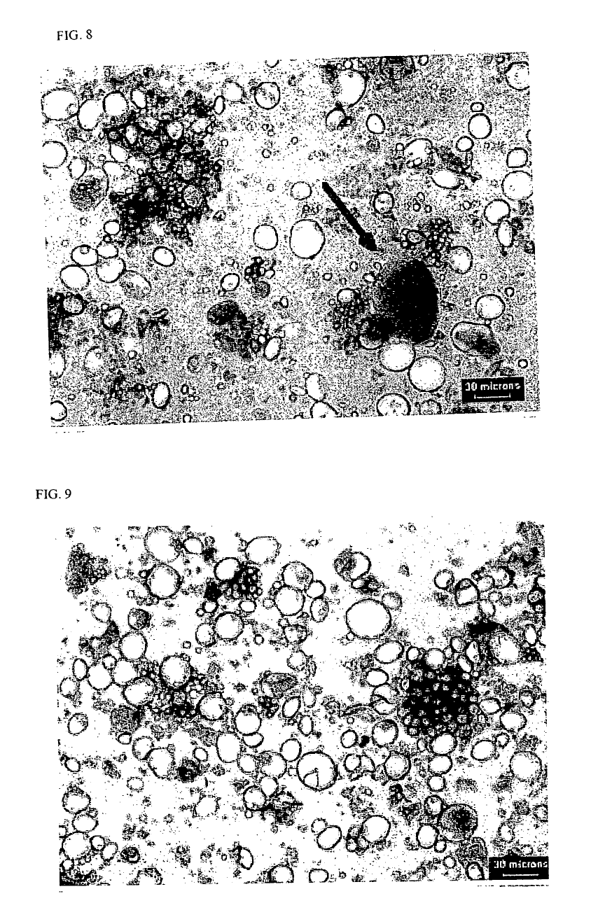

FIG. 5 is a graph showing a viscosity profile of the corn flour obtained by the above process representing an embodiment of the present invention, and a comparison viscosity profile of traditionally dry-milled corn flour, as measured on a Rapid Viscso Analyzer using standard sample analyzing protocols therefor. The traditionally dry-milled corn flour was a representative commercially-available product. The pasting profiles in FIG. 5 show that the viscosity of the cyclonically processed grain flour was not substantially different from that of the traditionally dry-milled corn flour. Importantly, there was no instant, or cold water, viscosity shown by the cyclonically milled flour, which indicates absence of significant gelatinization of starch in the flour product.

The corn flour made using the cyclonic processing was shelf stable, and it was functionally suitable for use as a food preparation ingredient.

### Example 2

Ground whole grain stability was investigated for various grains processed at different process air temperatures in the WINDHEXE apparatus. The various grains were each processed in a WINDHEXE apparatus of similar equipment configuration and processing conditions as described in Example 1. The ground products were then stored for 4 weeks at ambient conditions. After 4 weeks of storage at ambient conditions, all samples were sensorily evaluated by experienced evaluators for taste and aroma and found to be acceptable for use as a food preparation ingredient. The test results are set forth in Table 1 below.

TABLE 1

| Whole Grain | Process Temp. | Hexanal (ppm) | Taste/Aroma |
|---|---|---|---|
| Corn | Ambient | 2.52 | Acceptable |
| Corn | 250 F. | 0.33 | Acceptable |
| Rice | Ambient | 0.40 | Acceptable |
| Rice | 250 F. | 0.72 | Acceptable |
| Barley | 250 F. | 1.16 | Acceptable |
| Rye | 250 F. | 0.18 | Acceptable |

By comparison, ground whole grains prepared on a conventional piece of equipment with mechanical moving parts contacting the grain during milling, such as a hammer mill, typically may become rancid in 1 to 2 weeks with hexanal levels greater than 5 ppm and have unacceptable taste and aroma with typical rancid character.

### Example 3

Several whole grains were processed in a WINDHEXE apparatus under conditions similar to those described in Example 1, with no moving parts, and for comparison separate samples of the same types of grains were via conventional roller technology. In this regard, red soft whole wheat (RSWW) and white soft whole wheat (WSWW) were milled via a conventional milling process comprising milling untempered whole grains using conventional corrugated milling rolls, which were compared separate samples of the RSWW and WSWW which were subjected to processing in the WINDHEXE apparatus with feed air pre-heated to 250° F. Lipoxygenase activities of these samples were measured and compared. Lipoxygenase activity was measured using the method of Hamberg et al. using linoleic acid as the substrate. Hamberg, M., et al., (1967) J. Biol. Chem. 242, 5329. As shown in FIG. 6, the “WSWW 250F” sample prepared according to an embodiment of the present invention had about 60% decrease in lipoxygenase activity compared to the conventional milled flours “RSWW Ctrl” and “WSMM Ctrl”.

FIG. 7 shows the generation of the free fatty acid linoleic acid in the same flours during a storage study conducted for 60 days at ambient conditions. The samples were kept in air tight glass jars during the storage period other than when sampled and tested for fatty acid content. At the end of 60 days, a ground grain sample in accordance with the present invention (“250F White”) that had been processed with air at 250° F. had the lowest level of linoleic level. Its fatty acid level was 417 ppm, which was nearly three times less than the conventional milled flours.

Characteristics of the cyclonically milled flours also were observed to be unique as compared to conventional roller milling in that a finer particle size was achieved and greater enzyme deactivation was made possible. Also, referring to FIGS. 5-6, as observed and confirmed via microscopy (300× magnification), the starch granules in the resulting flour processed in accordance with embodiments herein were generally spherical in shape rather than the typical flattening that occurs in conventional roller milled grains, although the implications of this phenomena are not yet fully understood. In particular, FIG. 5 is a microphotograph (300×) of a sample of conventional milled red soft whole wheat (sieved −270 mesh, <53 μm), which was stained with aqueous Trypan Blue. Large flattened, and thus damaged, starch granules were stained blue, such as indicated by the shaded feature identified by the arrow included in FIG. 5. FIG. 6 is a microphotograph (300×) of a sample of red soft whole wheat (sieved −270 mesh, <53 μm), which was milled in a cyclone grinding unit in a manner as described in this example, which also was stained with aqueous Trypan Blue. In FIG. 6, no large flattened starch granules were observed.

Baking Quality Study:

The baking quality of red soft wheat flours ground in the cyclonic apparatus at various air temperatures also was investigated. Different batches of red soft wheat grain were tempered (i.e., soaked in water) and then processed in the cyclonic apparatus and under similar process conditions as described above in this same example. The red soft wheat grains processed were 100% whole grains, including bran and germ. A control flour (“ctrl”; Climax flour from Toledo Flour mill) also was obtained and used for the cookie dough tests that follow, which was 100% white flour (no bran). The % moisture content of all the test and control flours were measured. In a first set of tests, cookie doughs were prepared using the various test and control flours in a generally conventional manner in a dough forming stage using the following general formulation:

Dough Formulation

| Dough Ingredient | Amount (lbs.) |
|---|---|
| wheat flour | 100 |
| granulated sugar | 20-60 |
| salt | 0.5-2.0 |
| sodium bicarbonate | 0.25-2.0 |
| vegetable oil | 20-60 |
| whey | 0.25-8.0 |
| corn syrup | 0.25-12 |
| ammonium bicarbonate | 0.25-2.0 |
| dibasic ammonium phosphate | 0.25-2.0 |
| water | 8-30 |

In accordance with AAAC baking procedures, the cookie doughs were shaped, baked, and then analyzed for % weight loss (baking), average hardness, and average stickiness. Generally, the cookie dough ingredients were thoroughly mixed to form dough, proofed, and wire cut into individual dough pieces having generally circular profiles. The cookies were baked for approximately 6 minutes in an air impingement oven through which they were conveyed. The temperature of the baking chamber ranged from between 350 to 450° F. The baked cookies were cooled and tested. As a second set of tests, cookies were prepared in a similar manner as the first set except that cookie batches using the various tests flours prepared in the cyclonic apparatus were co-blended with 50% control flour as a “50% replacement” study.

Table 2 below summarizes the % moisture (flour), % weight loss (baking), the average width and length of cookie samples (based on 4 measured cookies, cm), the average stack height (based on 10 measured cookies, cm), the average hardness, and average stickiness, for the various tested flours and cookies made therewith for both sets of cookie flour data.

TABLE 2

| | | | | | | | | | |
|---|---|---|---|---|---|---|---|---|---|
| | | | | % | | | | | |
| | | | % | weight | | | | | |
| | Milling | Tempering | moisture | loss | | | Stack | ave. | ave. |
| Sample | Temp. | Time | (flour) | (baking) | Width | Length | Height | hardness | stickiness |

Set 1: 100%
Replacement

| | | | | | | | | | |
|---|---|---|---|---|---|---|---|---|---|
| 1 | 400° F. | 2 hr | 0.84 | 8.16 | 26.7 | 28.2 | 4.30 | 203.15 | −107.42 |
| 2 | 325° F. | 2 hr | 1.99 | 9.13 | 28.6 | 29.9 | 3.90 | 161.23 | −87.48 |
| 3 | 250° F. | 2 hr | 3.30 | 9.73 | 29.7 | 30.9 | 4.00 | 146.12 | −77.98 |
| 4 | Ambient | 2 hr | 10.18 | 10.90 | 30.2 | 31.5 | 3.80 | 118.11 | −67.78 |
| 5 | 400° F. | Over- | 0.80 | 7.53 | 26.0 | 27.0 | 4.50 | 267.76 | −134.28 |
| | | night | | | | | | | |
| 6 | 325° F. | Over- | 1.66 | 8.36 | 27.9 | 29.8 | 3.90 | 189.17 | −98.47 |
| | | night | | | | | | | |
| 7 | 250° F. | Over- | 3.60 | 10.00 | 29.4 | 30.7 | 3.50 | 139.53 | −77.28 |
| | | night | | | | | | | |
| 8 | Ambient | Over- | 12.62 | 9.91 | 30.5 | 30.9 | 3.70 | 118.00 | −64.97 |
| | | night | | | | | | | |
| Ctrl | N/A | N/A | 13.36 | 13.42 | 33.0 | 34.0 | 2.70 | 74.56 | −46.77 |

Set 2: 50%
Replacement

| | | | | | | | | | |
|---|---|---|---|---|---|---|---|---|---|
| 9 | 400° F. | 2 hr | 0.84 | 9.61 | 29.6 | 29.9 | 3.80 | 128.07 | −73.75 |
| 10 | 325° F. | 2 hr | 1.99 | 10.04 | 30.9 | 31.5 | 3.50 | 130.27 | −74.79 |
| 11 | 250° F. | 2 hr | 3.30 | 10.71 | 30.9 | 31.7 | 3.60 | 112.07 | −62.56 |
| 12 | Ambient | 2 hr | 10.18 | 11.15 | 31.5 | 31.8 | 3.30 | 90.86 | −52.41 |
| 13 | 400° F. | Over- | 0.80 | 9.98 | 28.7 | 29.4 | 3.70 | 129.67 | −70.47 |
| | | night | | | | | | | |
| 14 | 325° F. | Over- | 1.66 | 10.34 | 30.4 | 31.5 | 3.50 | 112.15 | −63.86 |
| | | night | | | | | | | |
| 15 | 250° F. | Over- | 3.60 | 10.78 | 32.2 | 32.7 | 3.00 | 116.54 | −64.70 |
| | | night | | | | | | | |
| 16 | Ambient | Over- | 12.62 | 10.74 | 31.4 | 31.5 | 3.10 | 92.21 | −53.18 |
| | | night | | | | | | | |
| Ctrl | N/A | N/A | 13.36 | 13.42 | 33.0 | 34.0 | 2.70 | 74.56 | −46.77 |

The results in Table 2 show that the whole wheat grains processed at lower air temperatures in the cyclonic grinding apparatus had superior cookie baking properties as compared to whole wheat grains processed at 400° F.

### Example 4

Two unblanched and two blanched batches of soybeans were processed in the WINDHEXE apparatus, then stored and analyzed.

The various batches were each processed in a WINDHEXE apparatus of similar equipment configuration and processing conditions as described in Example 1. The particular process conditions used for the four tested batches of soybeans are described below.

SoyBean Run # 1: Processing at 70° F. (ambient conditions: “RT”)

50 lbs. unblanched soybeans were processed in the WINDHEXE apparatus with compressed air pre-heated to 70° F. (outside ambient air temperature was <70° F.), air pressure was 52 psi, and the exhaust air temperature was 68-70° F. The product obtained included some large particulates which were mainly hulls. The final product was sifted to remove the hulls. The final product obtained comprised a fine powder having a tan color and was collected for analysis.

Soybean Run # 2: Processing at 260° F.

Unblanched soybeans were processed similar to soybean run # 1 except the compressed air temperature was at 250-260° F., air pressure was 62 psi, and exhaust air temperature was 247-250° F. Similar to soybean run # 1, the final product was sifted to remove large particulates. The final product was a fine powder having a tan color.

Soybean Run # 3: Processing Preblanched Soybeans at 365° F. (“BI 30 min”)

In a pressure cooker, 65 lb. of soybeans were cooked under a constant steam pressure of 10-15 psi for 30 minutes. The cooker was rotating during cooking to ensure uniform mixing. The blanched soybeans were soft and slightly darkened in color. The soybeans were then processed in the WINDHEXE apparatus at air temperature 365° F., air pressure of 65 psi, exhaust air temperature of 350° F., and the ground product was in powder form at a temperature of about 200° F. The final product was a very fine powder without any large particulate; therefore there was no need for sifting. A preliminary processing trial was carried out at around 400° F. in which the ground product came out dark and toasted. However, when the processing temperature of 365° F., as indicated above for Run #3, produced a product that was lighter in color and had greatly reduced toasty taste.

Soybean Run # 4: Processing Preblanched & Precooled Soybeans at 300° F. (“BI 20 min”)

The soybeans were blanched for 20 minutes under a constant steam pressure of 10-15 psi; and the blanched soybeans were then rinsed in cold water. The water was drained from the blanched and cooled soybeans, and the soybeans were processed in the WINDHEXE apparatus at an air temperature of 300° F., an air pressure of 46 psi, an exhaust temperature of 262° F., and the product collected was a very fine powder without any large particulate having a color lighter than that of the product powder of Soybean Run #3, and the product powder had a temperature of about 138° F.

The ground products obtained from the four processed batches of soybeans were then stored in air-tight containers for 16 weeks at ambient conditions (i.e., about 70° F., relative humidity (RH)=about 50%). After storage, all samples were analyzed for moisture content, free fatty acid content (oleic and linoleic acids), and also lipoxygenase and lipase activities. A freshly ground sample of the soy beans (“Fresh Ground”)), which was provided by grinding a portion of the original lot of soybeans in a Waring blender into a flour, which was analysed as a control sample (“Soy ctrl”). A commercial soy flour (an Archer Daniels Midland soy flour product) also was tested as a comparison sample (Run 5). The moisture and free fatty acid analyses results are set forth in Table 3 below.

TABLE 3

| | Fresh | | | | | |
|---|---|---|---|---|---|---|
| | Ground | Run 1 | Run 2 | Run 3 | Run 4 | Run 5 |
| | (Soy | (Soy | (Soy | (Soy BI | (Soy BI | (soy com- |
| | ctrl) | RT) | 260 F) | 30 min) | 30 min) | parison) |
| % moisture | 12 | 7.00 | 3.20 | 3.40 | 4.40 | 4.10 |
| Oleic Acid | 21 | 87 | 15 | 31 | 23 | 71 |
| (ppm) | | | | | | |
| Linoleic | 65 | 216 | 37 | 63 | 64 | 235 |
| Acid | | | | | | |
| (ppm) | | | | | | |

As seen in Table 2, the soy product milled in the vortex processor at 260° F. had lower oleic and linoleic free fatty acid content than the soy processed at ambient conditions, preblanched ground products, and the fresh ground material. It also provided the lowest moisture product.

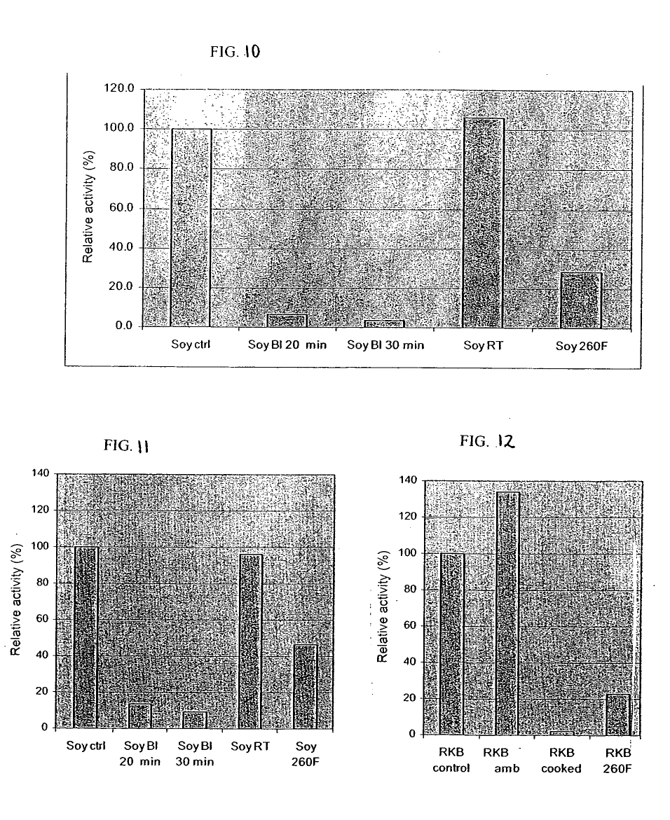

Also, lipoxygenase and lipase activities of these ground soy bean samples were measured and compared. Lipoxygenase activities were measured using the above-referenced method of Hamberg et al. Lipase activities were measured using the method of Blake et al., which is a spectrophotometric method based on the hydrolysis of a chromogenic substrate p-nitrophenol butyrate. The results are shown in FIGS. 10 and 11, respectively. As shown in FIG. 10, a significant reduction (approx 70%) in lipoxygenase activity was obtained in the vortex-milled soy samples processed at 260° F. No significant difference in lipoxygenase activity was obtained in the soy flour obtained from the soy sample vortex-milled at ambient conditions. This indicates that the vortex process inactivates enzymes in pulses such as soya beans at a temperature around about 260° F. The ambient-processed soy sample had a higher activity than fresh ground, which is thought possibly attributable due to particle size difference, as fresh ground material was not as finely ground as the vortex-processed samples. Blanching the grains prior to milling eliminated 95% of the lipoxygenase activity activity. Referring to FIG. 11, a significant reduction (56% reduction) in lipase activity was obtained in the vortex-processed soy at 260° F. About 90% of the activity was eliminated when the grains were blanched prior to vortex milling. No significant difference in lipase activity was obtained when the soy was milled at ambient conditions. Cooking the soy beans prior to vortex processing decreased the lipase activity even more significantly, but required the additional cooking step. The soy processed at ambient conditions had a higher activity than fresh ground, which is thought possibly attributable due to particle size difference, as fresh ground material was not as finely ground as the vortex-processed soy.

### Example 5

Two unblanched batches and one blanched batch of fresh red kidney beans obtained from a commercial grocer market were processed in the WINDHEXE apparatus, then stored and analyzed.

The various batches were each processed in a WINDHEXE apparatus of similar equipment configuration and processing conditions as described in Example 1. The particular process conditions used for these tested batches of soybeans are described below.

Red Kidney Bean Run # 1: Processing at 70° F. (“RKB amb”)

50 lbs. unblanched red kidney beans were processed in the WINDHEXE apparatus with compressed air pre-heated to 70° F. (outside ambient air temperature was <70° F.), an air pressure of 48-52 psi, and an exhaust air temperature of 65-70° F. The ground product was sifted to remove large particulates. The final product was a fine powder having a tan color.

Red Kidney Bean Run # 2: Processing 250-260° F. (“RKB 260F”)

50 lbs. unblanched red kidney beans were processed in the WINDHEXE apparatus with compressed air pre-heated to 253° F., an air pressure of 58-62 psi, and an exhaust air temperature 247-250° F. The ground product was sifted to remove large particulates. The final product was a fine powder having a tan color.

Red Kidney Bean Run # 3: Processing Preblanched Red Kidney Beans at 300° F. (“RKB cooked”)

In a pressure cooker, 50 lb. of red kidney beans were cooked under a constant steam pressure of 10-15 psi for 30 minutes. The cooker was rotating during cooking to ensure uniform mixing. The blanched kidney beans were soft and slightly darkened in color. The soybeans were then processed in the WINDHEXE apparatus at air temperature 300° F., air pressure of 58-62 psi, exhaust air temperature of 280-290° F., and the ground product was in powder form at a temperature of about 175° F. The final product was sifted to remove large particulates. The final product was a very fine powder having a tan color.

The ground products obtained from the above three processed batches of red kidney beans were stored for 8 weeks at ambient conditions (i.e., about 70° F., RH=about 50%). After storage, all samples were analyzed for moisture, free fatty acid and lipase activity, to assess the stability of the products. Freshly ground kidney beans also were prepared by grinding a portion of the original lot with a Waring blender, and the resulting flour was analyzed as a control sample (“RKB ctrl”). The analyses results are set forth in Table 4 below.

TABLE 4

| | Fresh | | | |
|---|---|---|---|---|
| | Ground | Run 1 | Run 2 | Run 3 |
| | (RKB | (RKB | (RKB | (RKB |
| | Ctrl) | amb) | 260 F.) | cooked) |
| % moisture | 12 | 10.20 | 3.30 | 3.20 |
| Oleic Acid | 81 | 133 | 74 | 52 |
| (ppm) | | | | |
| Linoleic | 157 | 333 | 117 | 95 |
| Acid | | | | |
| (ppm) | | | | |

Also, lipase activities of these ground kidney bean samples were measured and compared. The results are shown in FIG. 12 where it is shown that approximately 80% lipase activity was inactivated in red kidney beans when processed at 260° F. Cooking the beans decreased the activity further by approximately 98%. The kidney beans which were vortex processed ambient conditions had a higher activity than fresh ground, which is thought attributable to particle size difference, as fresh ground material was not as finely ground as the vortex-milled product.

### Example 6

An instant whole grain food product was prepared from grain, which was precooked, and then ground and dried in a WINDHEXE apparatus, and then the ground grain-based product was reconstituted with water, shaped and cooked to provide an instant whole grain food product.

Particularly, a mixture comprising 77% whole grain wheat and 23% water was placed in a cooker preheated to a temperature of 260° F., and cooked for 45 minutes at 20 psi steam pressure. The total water content of the mixture, prior to cooking, was about 34-38%, based on the total weight of added water and moisture content of the grain ingredient. The precooked grain mixture was introduced into a WINDHEXE apparatus similar to the one described in Example 1 with air temperature at 257-330° F. and pressure of 53-60 psi. A flowable particulated product emerged from the discharge end of the processing apparatus within a several seconds as a flowable particulate having a product temperature of 190° F. and moisture content <12%. To prepare an instant whole grain product, another mixture comprising 71 % processed grain product granulate and 29% water was mixed about 5 minutes, and then was shredded. Layers of the shredded mass were compressed using a smooth pressure roller to a desired snack chip thickness, cut to desired chip shape, and baked to attain a target moisture content of 2%. The resulting chip base product also was flavored via oiling and seasoning. The base product chips were introduced into a drum/tumbler and surface sprayed with oil, followed by introduction of addition of seasonings (e.g., salt, cheese powder). The surface-coated snack product was allowed to dry, providing a tasty snack food which could be consumed immediately or packaged and stably stored.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A granulation process for edible seeds, comprising:
introducing compressed air into a vortex grinding apparatus that includes a truncated conical shaped section, wherein the introduced air travels along a downward path through the apparatus, including the conical section, to a lower end thereof, and the air reaching the lower end flows back up and exits the enclosure via an exhaust outlet;
introducing into the enclosure edible seeds which are entrained in the introduced air traveling downward through the enclosure, wherein at least a portion of the edible seeds are ground before reaching the lower end of the apparatus;
discharging a granular product from the lower end of the apparatus.

2. The process of claim 1, wherein the edible seeds are grain selected from the group consisting of wheat, maize, oats, barley, rice, rye, sorghum, milo, rape seed, millet, triticale, and mixtures thereof.

3. The process of claim 1, wherein the edible seeds contain endogenous lipoxygenase and/or lipase.

4. The process of claim 3, wherein the edible seeds comprise oats.

5. The process of claim 1, wherein the edible seeds contain tocopherol, a naturally occurring tocopherol salt, or a mixture thereof.

6. The process of claim 1, wherein the edible seeds comprise pulse seeds.

7. The process of claim 1, wherein the edible seeds are selected from the group consisting of soya beans, kidney beans, peanuts, chickpeas, faba beans, field peas, lentils, lupins, mung beans, navy beans, and mixtures thereof.

8. The process of claim 1, wherein the edible seeds contain less than 14 wt. % moisture as introduced into the apparatus.

9. The process of claim 1, wherein the granular product has an average particle size of about 1 micron to about 1,000 microns.

10. The process of claim 1, wherein the introducing of the compressed air comprises supplying compressed air at a pressure within the range of from about 10 psig to about 100 psig.

11. The process of claim 1, wherein the introducing of the compressed air comprises supplying compressed air at a pressure within the range of from about 32 psig to about 52 psig.

12. The process of claim 1, wherein the introducing of the compressed air comprises supplying the compressed air at a temperature not exceeding about 275° F.

13. The process of claim 1, wherein the introducing of the compressed air comprises supplying the compressed air at a temperature within the range of about 50° F. to about 260° F.

14. The process of claim 1, wherein the introducing of the compressed air comprises supplying the compressed air at a rate of within the range of from about 500 cubic feet per minute to about 10,000 cubic feet per minute.

15. The process of claim 1, wherein the edible seeds comprise whole wheat grain and the granular product contains less than about 1000 ppm linoleic acid after 60 days storage at ambient conditions subsequent to the discharging from the apparatus.

16. The process of claim 1, wherein the edible seeds comprise whole wheat grain and the granular product contains less than about 5 ppm hexanal.

17. The process of claim 1, wherein the edible seeds comprise whole wheat grain and the granular product contains less than about 3 ppm hexanal.

18. The process of claim 1, wherein the edible seeds comprise whole wheat grain and the lipoxygenase activity of the granular product is at least 25% lower as compared to a similar grain that instead is conventionally mechanical milled.

19. The process of claim 1, wherein the edible seeds comprise whole wheat grain and the lipoxygenase activity of the granular product is at least 25% lower as compared to a similar grain that instead is conventionally mechanical milled.

20. A process for making an instant whole grain food product prepared from grain in a method comprising
(a) cooking whole grain in the presence of water;
(b) (i) introducing compressed air into a vortex grinding apparatus that includes a truncated conical shaped section, wherein the air travels along a downward path through the apparatus, including the conical section, to a lower end thereof, and the air reaching the lower end flows back up and exits the apparatus via an exhaust outlet, (ii) introducing into the apparatus the cooked grain which is entrained in the air traveling downward through the apparatus, wherein at least a portion of the grain is ground before reaching the lower end of the apparatus, and (iii) discharging from the lower end of the apparatus a granulated product that is more stable than a similar grain which has been mechanically milled;
(c) combining the granulated product with water, and shaping and cooking the resulting mass to form an instant whole grain food product.

21. A granular food product prepared from edible seeds in a method comprising introducing compressed air into a vortex grinding apparatus that includes a truncated conical shaped section, wherein the air travels along a downward path through the apparatus, including the conical section, to a lower end thereof, and the air reaching the lower end flows back up and exits the enclosure via an exhaust outlet; introducing into the apparatus edible seeds which are entrained in the air traveling downward through the apparatus, wherein at least a portion of the edible seeds are ground before reaching the lower end of the apparatus; and discharging from the lower end of the apparatus a granulated product.

22. The granular food product of claim 21, wherein the edible seeds are grain selected from the group consisting of wheat, corn, oats, barley, rice, rye, sorghum, milo, rape seed, soy beans, kidney beans, and mixtures thereof.

23. The granular food product of claim 21, wherein the edible seeds contain endogenous lipoxygensase and/or lipase.

24. The granular food product of claim 21, wherein the edible seeds are pulse seeds.

25. The granular food product of claim 21, wherein the edible seeds are selected from the group consisting of soya beans, kidney beans, peanuts, chickpeas, faba beans, field peas, lentils, lupins, mung beans, navy beans, and mixtures thereof.

26. An instant whole grain food product prepared from grain in a method comprising (a) cooking whole grain in the presence of water; (b) (i) introducing compressed air into a vortex grinding apparatus that includes a truncated conical shaped section, wherein the air travels along a downward path through the apparatus, including the conical section, to a lower end thereof, and the air reaching the lower end flows back up and exits the apparatus via an exhaust outlet, (ii) introducing into the apparatus the cooked grain which is entrained in the air traveling downward through the apparatus, wherein at least a portion of the grain is ground before reaching the lower end of the apparatus, and (iii) discharging from the lower end of the apparatus a granulated product that is more stable than a similar grain which has been mechanically milled; (c) combining the granulated product with water, and shaping and cooking the resulting mass to form an instant whole grain food product.
